(19) United States
(12) Patent Application Publication
(10) Pub. No.: US 2016/0286461 A1
(43) Pub. Date: Sep. 29, 2016

(54) DATA LINK BEHAVIOR FOR MERGER OF WIRELESS NETWORK CLUSTERS

(71) Applicant: QUALCOMM Incorporated, San Diego, CA (US)

(72) Inventors: Abhishek Pramod Patil, San Diego, CA (US); Santosh Paul Abraham, San Diego, CA (US); George Cherian, San Diego, CA (US); Alireza Raissinia, Monte Sereno, CA (US)

(21) Appl. No.: 15/078,358

(22) Filed: Mar. 23, 2016

Related U.S. Application Data
(60) Provisional application No. 62/138,938, filed on Mar. 26, 2015.

(51) Int. Cl. H04W 40/32

(52) U.S. Cl. CPC H04W 40/32; H04W 84/18

(57) ABSTRACT

Systems, methods, and devices are disclosed for managing possible mergers between neighbor-aware or social Wi-Fi network clusters in a wireless network. In one aspect, a method includes identifying, at a device of a first wireless network cluster, a neighboring wireless network cluster. The method further includes determining whether to merge with the neighboring wireless network cluster based on a cluster grade of first wireless network cluster and a cluster grade of the neighboring wireless network cluster. The method further includes announcing a decision to merge the device with the neighboring wireless network cluster.

### CROSS REFERENCE TO RELATED APPLICATIONS

This application claims priority benefit under 35 U.S.C. §119(e) to U.S. Provisional Patent Application No. 62/138,938 entitled “DATA LINK BEHAVIOR FOR MERGER OF WIRELESS NETWORK CLUSTERS” filed on Mar. 26, 2015, the disclosure of which is hereby incorporated by reference in its entirety.

### BACKGROUND

1. Technological Field

The present disclosure is generally related to neighbor-aware networking and more particularly to systems, methods, and devices for managing possible mergers between neighbor-aware or social Wi-Fi network clusters in a wireless network.

2. Description of the Related Art

In many telecommunication systems, communications networks are used to exchange messages among several interacting spatially-separated devices.

Wireless networks are often preferred when the network elements are mobile and thus have dynamic connectivity needs, or if the network architecture is formed in an ad hoc, rather than fixed, topology. Wireless networks employ intangible physical media in an unguided propagation mode using electromagnetic waves in the radio, microwave, infra-red, optical, or other frequency bands. Wireless networks may advantageously facilitate user mobility and rapid field deployment when compared to fixed wired networks.

One or more devices in a wireless network may be configured to provide services. For example, a device may include hardware, such as a sensor, that is used to capture data. An application running on the device may then use the captured data to perform an operation. In some cases, the captured data may be useful to other devices in the wireless network. Some of the other devices in the wireless network may include similar hardware so as to capture similar data. Alternatively, the device could provide these services (e.g., the captured data) to one or more other devices in the wireless network. The device may inform the one or more other devices in the wireless network of the services that the device provides by advertising this information over the wireless network. Other devices may further advertise the services provided by a device to other devices not within range or capable of direct communication with the service provider.

### SUMMARY

One aspect disclosed is a method for managing wireless communication. The method comprises identifying, at a device of a first wireless network cluster, a neighboring wireless network cluster. The method further comprises determining whether to merge with the neighboring wireless network cluster based on a cluster grade of first wireless network cluster and a cluster grade of the neighboring wireless network cluster. The method further comprises announcing a decision to merge the device with the neighboring wireless network cluster.

Another aspect disclosed is a wireless communication device in a group supported by a first wireless network cluster. The wireless device comprises a processor configured to identify a neighboring wireless network cluster. The processor further configured to determine whether to merge with the neighboring wireless network cluster based on a cluster grade of first wireless network cluster and a cluster grade of the neighboring wireless network cluster. The processor further configured to announce a decision to merge the device with the neighboring wireless network cluster.

Another aspect disclosed is a wireless communication device in a group supported by a first wireless network cluster. The wireless device comprises means for identifying, at a device of a first wireless network cluster, a neighboring wireless network cluster. The wireless device further comprises means for determining whether to merge with the neighboring wireless network cluster based on a cluster grade of first wireless network cluster and a cluster grade of the neighboring wireless network cluster. The wireless device further comprises means for announcing a decision to merge the device with the neighboring wireless network cluster.

Another aspect disclosed is a non-transitory computer readable storage medium comprising instructions that when executed cause a processor to perform a method for managing wireless communication. The method comprises identifying, at a device of a first wireless network cluster, a neighboring wireless network cluster. The method further comprises determining whether to merge with the neighboring wireless network cluster based on a cluster grade of first wireless network cluster and a cluster grade of the neighboring wireless network cluster. The method further comprises announcing a decision to merge the device with the neighboring wireless network cluster.

### BRIEF DESCRIPTION OF THE DRAWINGS

FIG. 1 illustrates an example of a wireless network according to the disclosure.

FIG. 2 illustrates a wireless device of the wireless network of FIG. 1.

FIG. 3 depicts a neighbor aware network (NAN) having multiple neighbor aware network data link groups.

FIG. 4 illustrates a wireless network system with multiple wireless networks, NAN clusters, and wireless devices.

FIG. 5 illustrates an example of overlapping NAN clusters.

FIG. 6A is a first flowchart for merging NAN clusters.

FIG. 6B is a second flowchart for merging NAN clusters.

FIG. 7 is a third flowchart for merging NAN clusters.

### DETAILED DESCRIPTION

Various aspects of the novel systems, apparatuses, and methods are described more fully hereinafter with reference to the accompanying drawings. This disclosure may, however, be embodied in many different forms and should not be construed as limited to any specific structure or function presented throughout this disclosure. Based on the teachings herein one skilled in the art should appreciate that the scope of the disclosure is intended to cover any aspect of the novel systems, apparatuses, and methods disclosed herein, whether implemented independently of, or combined with, any other aspect of the invention. Although some benefits and advantages of the preferred aspects are mentioned, the scope of the disclosure is not intended to be limited to particular benefits, uses, or objectives.

Wireless network technologies may include various types of wireless local area networks (WLANs). A WLAN may be used to interconnect nearby devices together, employing networking protocols. The various aspects described herein may apply to any communication standard, such as a wireless protocol. In some implementations, a wireless local area network (WLAN) includes various devices that access the wireless network. For example, in some types of networks, there may be two types of devices: access points (“APs”) and clients (also referred to as stations, or “STAs”). In general, an AP may serve as a hub or base station for the WLAN and a STA serves as a user of the WLAN. In some implementations an STA may also be used as an AP. In other types of networks, STAs may communicate directly without use of an AP.

An AP may comprise, be implemented as, or known as a NodeB, Radio Network Controller (“RNC”), eNodeB, Base Station Controller (“BSC”), Base Transceiver Station (“BTS”), Base Station (“BS”), Transceiver Function (“TF”), Radio Router, Radio Transceiver, or some other terminology. A STA may also comprise, be implemented as, or known as an access terminal (“AT”), a subscriber station, a subscriber unit, a mobile station, a remote station, a remote terminal, a user terminal, a user agent, a user device, user equipment, or some other terminology. In some implementations an access terminal may comprise a cellular telephone, a cordless telephone, a Session Initiation Protocol (“SIP”) phone, a wireless local loop (“WLL”) station, a personal digital assistant (“PDA”), a handheld device having wireless connection capability, or some other suitable processing device connected to a wireless modem. Accordingly, one or more aspects taught herein may be incorporated into a phone (e.g., a cellular phone or smartphone), a computer (e.g., a laptop), a portable communication device, a headset, a portable computing device (e.g., a personal data assistant), an entertainment device (e.g., a music or video device, or a satellite radio), a gaming device or system, a global positioning system device, or any other suitable device that is configured to communicate via a wireless medium.

The 802.11s standard defines how wireless devices may communicate via mesh networks. Mesh networks may be used for static topologies and ad-hoc or neighbor aware networks (NAN). A NAN may also be a near-me area network or a neighborhood area network. The terms “Social Wi-Fi” (SWF) and “NAN” may be used interchangeably herein. A network may comprise a plurality of mesh devices, each of which is capable of relaying data within the network on behalf of other mesh devices in a SWF environment. The data transmitted or relayed between the mesh devices may similarly create a data link (“DL”) wherein the “link” describes the data flow from one mesh device to another. Accordingly, a SWF mesh may also be referred to as a NAN data link (NDL), comprising data transferred from a service provider to a service consumer, as described below. As described herein, a mesh may be generally referred to as comprising a plurality of DLs, although the two terms may be interchanged. A NDL may include more than one “hop.” A “hop” as used herein depends on the number of mesh devices between the device providing the service (provider device) and the device consuming the service or “subscribing” (subscriber device) to the service in the mesh network.

In various contemplated embodiments, a “mesh network group” or an “NDL group” is used. Accordingly, the devices that make up a mesh network may be the same as the devices that form an NDL group. The devices that make up an NDL group may be a subset of a NAN cluster that shares a paging window (PW). The PW for the NDL group may have common security credentials for each of the participating devices, which may serve to restrict membership within the NDL group. Accordingly, a restricted NDL group may require out-of-band credentialing.

The STAs within a mesh network may wish to form NDL groups in order to communicate with each other in a simple and secure manner. In some NANs, a STA may also wish to be part of more than one NDL group. If the STA is a member of two groups, for instance, the STA may receive communications from other STAs that are members of the first NDL group, the second NDL group, or both. Accordingly, the STA may wish to identify which NDL group a received communication is associated with. Further, the STA may wish to identify which NDL group a transmitted communication is associated with. Additionally, the members of a NDL group may wish to encrypt their communications so that only members of the NDL group may decipher and read the communication.

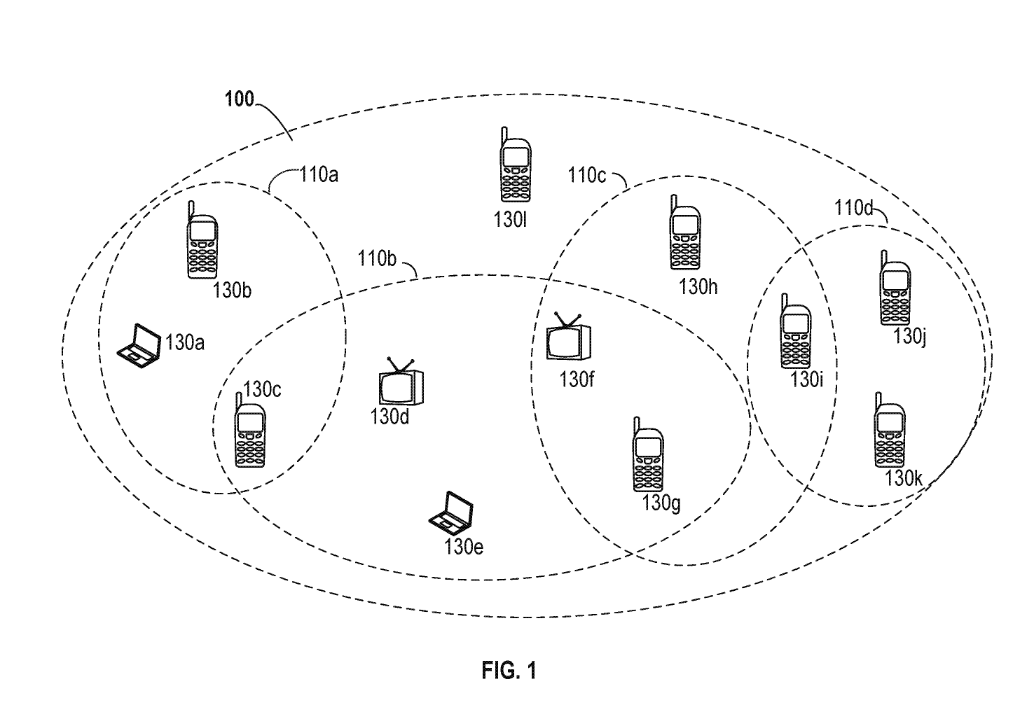

Referring to FIG. 1, a particular illustrative embodiment of a wireless network is depicted and generally designated 100. In some aspects, the wireless network 100 is a NAN. A NAN may also be referred to as an ad-hoc network in this disclosure. FIG. 1 illustrates wireless devices 130a-1301 (collectively referred to herein as the “devices” 130) are participating in the wireless network 100. Wireless devices 130 may also be referred to as “mobile” devices. For example, each of the devices 130 may receive beacon or other time synchronization information from one of the other wireless devices 130 within the wireless network 100. This information may be received through a multi-hop data link as described above. In at least one aspect, one of wireless devices 130 may be designated as a “root” or “anchor” node for the wireless network 100, and therefore periodically transmit synchronization messages that are received by each of the other devices 130. For example, the wireless device 130a may be the first device 130 to provide a first service, thus it may be referred to as the service initiator device, and may also be the “root” or “anchor” device responsible for the synchronization messages within a particular mesh or NDL group, e.g., NDL group 110a.

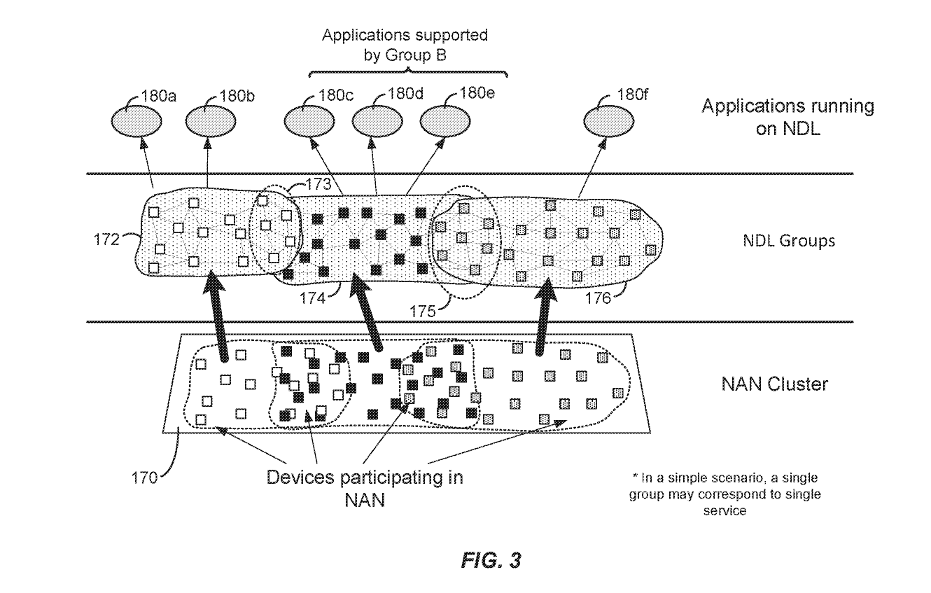

As shown, the wireless network 100 also may include four NDL groups 110a-110d, referred to collectively as the “NDL groups 110.” NDL groups may also be referred to herein as mesh networks or simply as “NDLs.” Each of the NDL groups 110 is shown including a portion of the wireless devices 130a-130k. The NDL group 110a includes wireless devices 130a-130c. The NDL group 110b includes wireless devices 130c-130g. The NDL group 110c includes wireless devices 130f-130i. The NDL group 110d includes wireless devices 130i-130k. As shown, the wireless device 130l is not currently included in any of NDL groups 110, however wireless device 130l may join an NDL as needed to subscribe to a desired service. In certain embodiments, some of the NDL groups 110 may be formed according to the service or services provided by the member(s) (devices 130) of the respective NDL groups 110. In some embodiments, an NDL group 110 may be formed at the start of an instance of a service (e.g., when a service initiator device first provides the service within the NAN). This formation process may be referred to herein as “spontaneous group formation” (described more fully in connection with FIG. 3). In other embodiments, an NDL group 110 may be formed out of the scope of the NAN by an out of band procedure. This formation process may be referred to herein as “out of band group formation” (described more fully in connection with FIG. 3). In certain embodiments, each NDL group 110 may include a plurality of multi-hop data links among the devices 130.

Communication within each of the NDL groups 110 may be performed on a different communication channel than other communication for wireless network 100. For example, each of NDL groups 110 may operate on a different communication channel, which is also different than the channel used to perform communication for the network 100. Additionally or alternatively, each of the members of the NDL groups 110 may communicate through the use of a different MAC address associated with each of the respective NDL groups 110. In this instance, a recipient of the communications may be able to determine which NDL group 110 the communication is associated with (e.g., wireless device 130g may be able to determine that a communication from wireless device 130f is associated with NDL group 110b, as opposed to NDL group 110c).

Each of the NDLs 110 may be utilized by one or more “provider devices” to provide a service to other member devices of the NDL groups 110. For example, the wireless device 130a may be a service providing device (provider device) for the NDL group 110a, which, in one example, provides a music service to wireless devices 130b-130c. The wireless device 130a may advertise the service being provided on the NDL group 110a to devices on wireless network 100. For example, wireless device 130a (or other provider devices on wireless network 100) may broadcast or multicast a message over the wireless network 100 indicating a service that can be provided and one or more parameters associated with obtaining the service. In addition, a provider device on wireless network 100 may respond to service discovery requests received from other potential subscriber devices on the wireless network 100 as described above. For example, provider device 130a may transmit a discovery response that includes information indicating the service being provided in the NDL group 110a.

Similarly, each of the NDL groups 110b-110d may also comprise a respective provider device that may operate similarly to the example of provider device 130a of NDL group 110a provided above. For example, the wireless device 130d may be the provider device 130d for NDL group 110b, offering a video game service to wireless devices 130c, 130e, 130f, and 130g. The wireless device 130h may be a provider device 130h for the NDL group 110c by providing a picture sharing service to wireless devices 130f, 130g, and 130i. Similarly, wireless device 130j (provider device 130j) may provide a video service over the NDL group 110d to wireless devices 130i and 130k. Accordingly, each of the wireless devices 130 that consumes or subscribes to the services of a given provider device (e.g., provider devices 130a, 130d, 130h, 130j) may also be referred to as a subscriber device. More particularly, in view of the provider devices 130a, 130d, 130h, 130j noted above, a “subscriber device” may generally refer to the subscriber devices 130b, 130c, 130e, 130f, 130g, 130i. However, in certain aspects, a wireless device 130a-130k may be classified as either a “provider device” or a “subscriber device” depending on the service architecture.

A given mobile device may be a member of two or more NDL groups 110 concurrently and therefore receive services provided by each of the provider devices 130 or provide services received by each of the subscriber devices 130 of the respective NDL groups 110. For example, the wireless device 130c is shown as a member of both NDL groups 110a and 110b. Thus, wireless device 130c may be concurrently receiving the music services provided by wireless device 130a and image services provided by wireless device 130d. Similarly, wireless devices 130f-g participate in NDL groups 110b and 110c, and wireless device 130i participates in both NDL groups 110c and 110d.

FIG. 1 illustrates that a wireless device providing a service over one NDL group may also receive services over a second NDL group. For example, in FIG. 1, the wireless device 130c may be receiving music services via NDL group 110a while providing a video game service to wireless devices 130d-g. In an embodiment, a single wireless device 130 may provide multiple services to multiple NDL groups. For example, wireless device 130c may provide a service for music in NDL group 110a to wireless devices 130a-b while simultaneously providing a service for video games in NDL group 110b to wireless devices 130d-g.

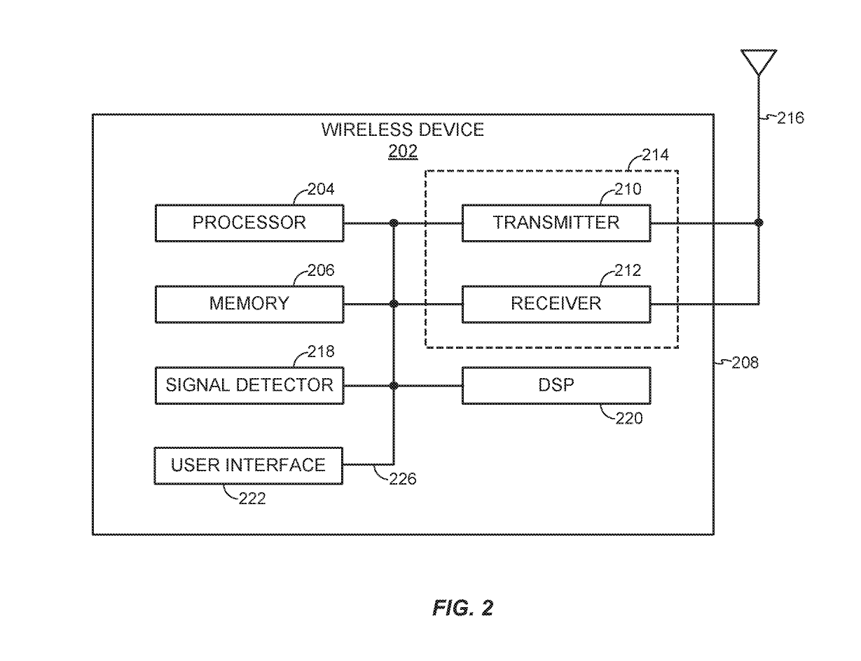

FIG. 2 shows an exemplary functional block diagram of a wireless device 202 that may be employed within the wireless network 100 of FIG. 1. The wireless device 202 is an example of a device that may be configured to implement the various methods described herein. For example, the wireless device 202 may comprise one of the stations 130a-1.

The wireless device 202 may include a processor 204 which controls operation of the wireless device 202. The processor 204 may also be referred to as a central processing unit (CPU). Memory 206, which may include both read-only memory (ROM) and random access memory (RAM), may provide instructions and data to the processor 204. A portion of the memory 206 may also include non-volatile random access memory (NVRAM). The processor 204 typically performs logical and arithmetic operations based on program instructions stored within the memory 206. The instructions in the memory 206 may be executable to implement the methods described herein.

The processor 204 may comprise or be a component of a processing system implemented with one or more processors. The one or more processors may be implemented with any combination of general-purpose microprocessors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that can perform calculations or other manipulations of information.

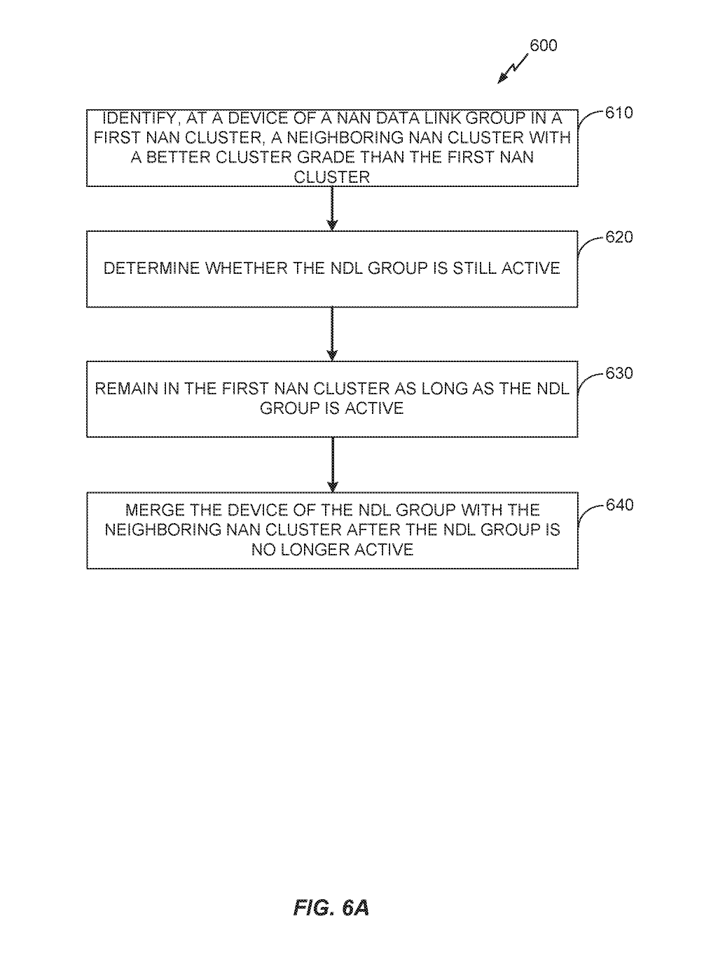

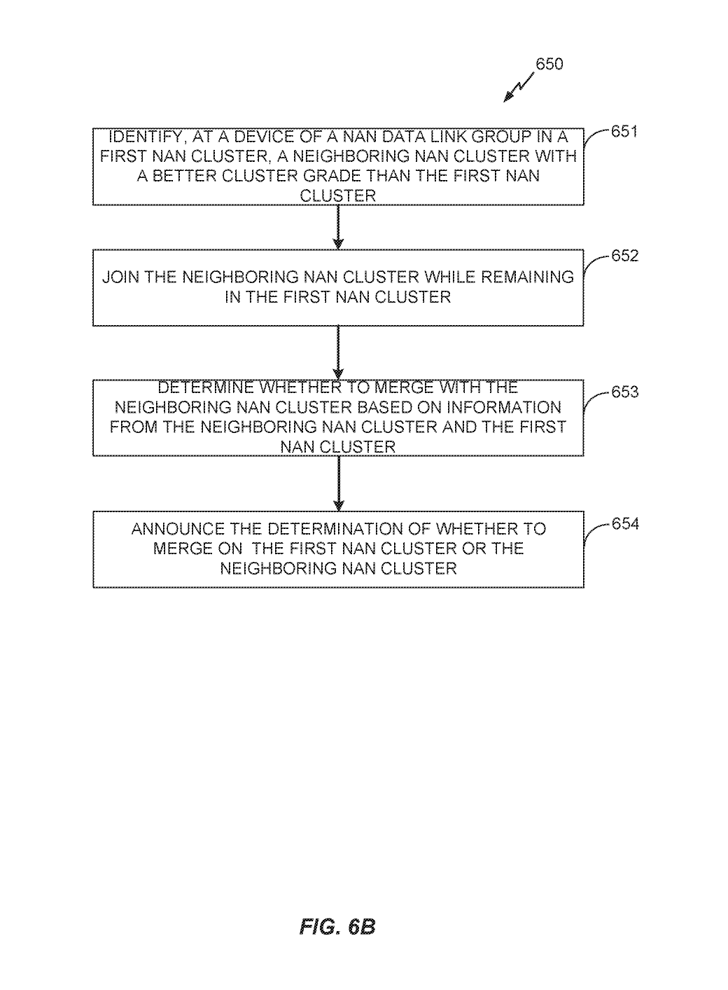

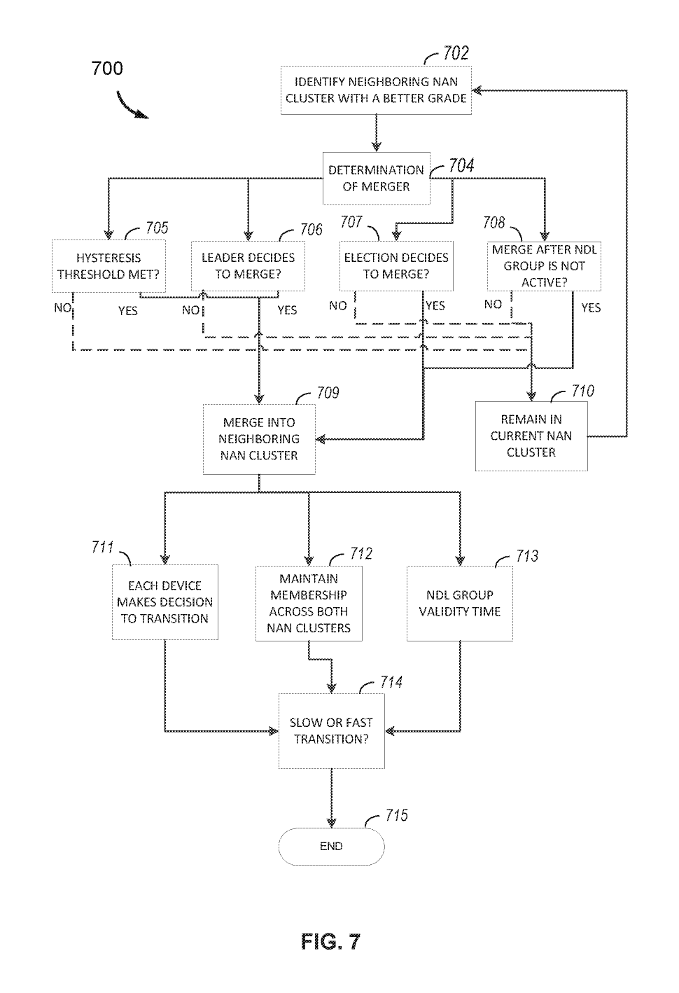

The processing system may also include machine-readable media for storing software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the one or more processors, cause the processing system to perform the various functions described herein. For example, the instructions stored in memory 206 may be executed by the processor 204 to implement the features described below in connection with the flow charts of FIGS. 6A, 6B, and 7.

The wireless device 202 may also include a housing 208 that may include a transmitter 210 and/or a receiver 212 to allow transmission and reception of data between the wireless device 202 and a remote location. The transmitter 210 and receiver 212 may be combined into a transceiver 214. An antenna 216 may be attached to the housing 208 and electrically coupled to the transceiver 214. The wireless device 202 may also include (not shown) multiple transmitters, multiple receivers, multiple transceivers, and/or multiple antennas.

The wireless device 202 may also include a signal detector 218 that may be used in an effort to detect and quantify the level of signals received by the transceiver 214. The signal detector 218 may detect such signals as total energy, energy per subcarrier per symbol, power spectral density and other signals. The wireless device 202 may also include a digital signal processor (DSP) 220 for use in processing signals. The DSP 220 may be configured to generate a packet for transmission. In some aspects, the packet may comprise a physical layer convergence protocol (PLCP) data unit (PPDU).

The wireless device 202 may further comprise a user interface 222 in some aspects. The user interface 222 may comprise a keypad, a microphone, a speaker, and/or a display. The user interface 222 may include any element or component that conveys information to a user of the wireless device 202 and/or receives input from the user.

The various components of the wireless device 202 may be coupled together by a bus system 226. The bus system 226 may include a data bus, for example, as well as a power bus, a control signal bus, and a status signal bus in addition to the data bus. Those of skill in the art will appreciate the components of the wireless device 202 may be coupled together or accept or provide inputs to each other using some other mechanism.

Although a number of separate components are illustrated in FIG. 2, those of skill in the art will recognize that one or more of the components may be combined or commonly implemented. For example, the processor 204 may be used to implement not only the functionality described above with respect to the processor 204, but also to implement the functionality described above with respect to the signal detector 218 and/or the DSP 220. Further, each of the components illustrated in FIG. 2 may be implemented using a plurality of separate elements.

The wireless device 202 may comprise any of wireless devices 130a-1, and may be used to transmit and/or receive communications. That is, any of wireless devices 130a-1 may serve as transmitter or receiver devices. Certain aspects contemplate signal detector 218 being used by software running on memory 206 and processor 204 to detect the presence of a transmitter or receiver.

As described above, a wireless device, such as wireless device 202, may be configured to provide services, receive services, or otherwise communicate within a wireless communication system, such as the wireless communication system 100. For example, the wireless device 202 may include hardware (e.g., a sensor, a global positioning system (GPS), etc.) that is used to capture or calculate data (e.g., sensor measurements, location coordinates, etc.).

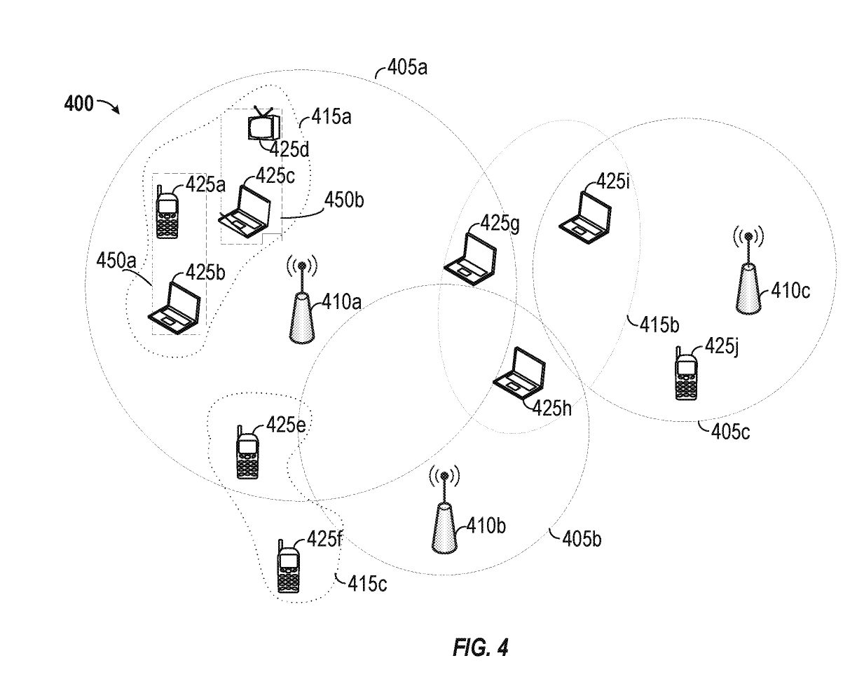

As discussed in the following figures, the disclosed methods and systems extend the capabilities of existing social Wi-Fi frameworks such as wireless network 100 to enable participating devices, such as wireless devices 130, to form NDL groups, and to communicate simply and securely within the NDL groups. To accomplish this, a set of parameters used to establish an NDL group comprising the wireless devices 130 may be defined. These parameters may also be used when communicating between the wireless devices 130 of the NDL groups 110, as discussed below with respect to FIG. 4. In some aspects, this set of parameters may be multicast or broadcast over the NAN, being included in one or more of the beacon transmissions, service advertisements, or other similar transmissions that may apprise a wireless device 130 of services available from a given network 110. In one embodiment, these parameters are included within an IEEE 802.11 MPDU.

Once the NDL is established by participating wireless devices 130, the service may be delivered to the devices of the NDL. In some aspects, devices 130 may subscribe or be participants of multiple mesh networks, as noted above to provide for the delivery of multiple services to the devices (e.g., wireless devices 130c, 130f). Similarly, the devices 130 may subscribe to more than one service and thus be members of more than one mesh network or mesh network group. Therefore, connectivity attributed for a given mesh network or multiple mesh networks may be advertised on a per-service basis. The communications associated with such devices 130 of NDL groups may be substantially similar to the methods and systems described below with respect to the following figures.

The methods and systems disclosed herein may utilize one or more communication parameters that function to define an NDL group within which a particular service is provided. These parameters assist a participating wireless device 130 in identifying communications associated with the appropriate NDL group 110 for service delivery, as they may uniquely identify an NDL group. These parameters may also assist a participating wireless device 130 in decrypting messages associated with differing NDL groups, which may require differing encryption credentials, as discussed below. By forming NDL groups and establishing a method of communication and a method of encryption thereof, operational efficiencies may be achieved in some aspects.

FIG. 3 depicts an illustrative embodiment of a NAN according to the disclosure. As shown, a plurality of devices within a cluster 170 are participating in the SWF NAN. The cluster 170, or SWF NAN, shown in this figure may be similar to the wireless network 100 (FIG. 1). The plurality of devices within the cluster 170 may further be similar to the devices 130. In an embodiment, each of the devices within the cluster 170 may be using a service or services offered by the members of the NAN as a whole. In some other embodiments, the service(s) may also be delineated by smaller groups within the cluster 170. The smaller groups may be referred to herein as NDL groups: a NDL group 172, a NDL group 174, or a NDL group 176. Each NDL group 172, 174, 176 may have a unique identifier associated therewith. Accordingly, a given NAN (e.g., the cluster 170) may comprise multiple NDLs, or NDL groups as described herein. Each of the NDL groups 172, 174, 176 may include a plurality of multi-hop data links among the devices, as depicted in the figure. Each of the respective NDLs (the NDL group 172, the NDL group 174, and the NDL group 176) may comprise a common service, a common operating system, a common platform (e.g., a particular brand of smartphone, or computer), or other relevant commonality. Each of the NDL groups 172, 174, 176 may then comprise an individual NDL group. As a non-limiting example, the NDL group 172 may form a SWF mesh for transport of data, while the NDL group 174 may utilize GPS services, video/photo sharing, or online gaming features. In some embodiments, there may be an identifier associated with the cluster 170, an identifier associated with each service offered by the members of the cluster 170, or both.

In an embodiment, the cluster 170 and the devices of the NDL groups 172, 174, 176 may be capable of supporting multiple services each. Within each NAN, or within each of the NDL groups 172, 174, 176 (within the NAN), each device may become a proxy for services provided by the respective devices of the NDL group or the NAN. In an embodiment, where an NDL group (e.g., the NDL groups 172, 174, 176) supports one or more services, all of the participating wireless devices 130 of the NDL group may proxy the services provided within the NDL group regardless of whether the individual proxy STA is actually consuming the service.

In an embodiment, a further abstraction may be implemented, delineating what particular applications 180 might be supported within a particular NDL group. In an embodiment, the STAs that are part of the NDL groups 172, 174, 176 (i.e., participating in the respective Social Wi-Fi mesh) may normally act as a proxy for service discovery packets for all the services supported within the NDL group, while also forwarding the data associated with the services supported within the particular NDL group 172, 174, 176. Therefore each NDL may comprise a plurality of STAs that consume and/or proxy one or more of the NDL's services.

The NDL groups 172, 174, 176 within the cluster 170 (or the network 100) may support various services (e.g., the NDL groups may contain wireless devices 130 providing a service), and multiple services may be supported within each of the NDL groups. For example, the applications 180a, 180b may be provided within the NDL group 172, the applications 180c-180e may be provided within NDL group 174, and the application 180f may be provided within NDL group 176. Further, some of the devices within the cluster 170 may be members of more than one NDL group. For example, the devices within the dotted portion 173 may be members of both NDL group 172 and NDL group 174, and the devices within the dotted portion 175 may be members of both NDL group 174 and NDL group 176. Accordingly, these devices may provide or receive services from more than one NDL group 172, 174, 176.

The NDL groups 172, 174, 176 may be formed through spontaneous group formation, out of band group formation, or some other method. In spontaneous group formation, an NDL group 172, 174, 176 may be formed at the start of an instance of a service (e.g., application 1800. The scope of the NDL group (e.g., NDL group 176) may be limited in scope to the cluster 170, and may not exist outside of the cluster 170. Security pass phrases for NDL groups 172, 174, 176 formed through spontaneous group formation may be created or programmed by applications running on or utilizing a mobile device within the NDL group 172, 174, 176 at the time of instantiation of the NDL group 172, 174, 176. These security pass phrases may be passed to the NAN MAC at this time. However, the NDL groups 172, 174, 176 formed via spontaneous group formation may not provide layer 2 security, which may be desired. Accordingly, in some embodiments, out of band (OOB) group formation may be utilized to form NDL groups 172, 174, 176.

In OOB group formation, NDL groups 172, 174, 176 may be formed outside of the scope of the cluster 170. Each of these NDL groups 172, 174, 176 may have a group name that maps to a group identifier. For example only, NDL group 174 may consist of high school students interested in a game, and may be named or associated with an identifier accordingly. Keys or passphrases for joining the group may be shared in the OOB procedure. In some embodiments, all, or at least some portion, of the NDL groups 172, 174, 176 may be formed in accordance with different methods. For example only, NDL group 172 may be formed through spontaneous group formation, NDL group 174 may be formed through OOB group formation, and NDL group 176 may be formed though some other procedure known in the art.

Each of the NDL group 172, 174, 176 may also part of the same security group. A group of STAs that can mutually authenticate each other may be referred to as a security group. In this instance, no two STAs would exist within the security group unless they could authenticate each other. The security group may be time and channel independent. The formation of the security group may also be OOB and the method of creation may be out of the scope of the cluster 170. In one exemplary embodiment, a security group may be formed through the use of an application running on or utilizing the mobile devices that are members of an NDL group (e.g., NDL group 174). In one embodiment, NDL groups 172, 174, 176 utilize a single logical channel and all subscribing members thereof are part of the same security group. In accordance with this embodiment, an NDL group 172, 174, 176 may have a common group key derived from the credentials of the security group. This group key may be used by the mobile devices within the NDL group 172, 174, 176 to encrypt a portion of the communications that are broadcast or multicast to other members of the NDL group 172, 174, 176. Each of the NDL groups 172, 174, 176 and/or members of the NDL groups may make a determination of whether to merge with a new NAN cluster when one comes within range of the current NAN cluster (e.g., NAN cluster 170).

FIG. 4 depicts an embodiment of a plurality of wireless networks and neighbor aware networks and associated wireless devices and server are depicted and generally designated 400. The wireless networks 405a, 405b, and 405c are depicted and contain a plurality of wireless devices 425a-j and wireless access points 410a-c.

Wireless devices 425a-e and 425g are each “members” of wireless network 405a. These six wireless devices 425a-e and 425g may be referred to as “members” of the wireless network 405a as the six noted wireless devices are either actively or passively participating in communications on the wireless network 405a. Each of these wireless devices 425a-e and 425g may be communicating with wireless access point 410a. Similarly, wireless device 425h is a member of wireless network 405b and may communicate with wireless access point 410b. Additionally, wireless device 425i and 425j are each members of wireless network 405c. These two wireless devices may communicate with wireless access point 410c. Wireless device 425f is not a member of any wireless network 405a-c, and thus may not be communicating with any of wireless access points 410a-c.

In FIG. 4, wireless devices 425a-d are each members of NAN cluster 415a through which each of these wireless devices may communicate with each other without communicating via wireless access point 410a. As discussed with respect to FIG. 3, NAN clusters may comprise one or more NDL groups. As shown in FIG. 4, NAN cluster 415a also comprises NDL groups 450a and 450b. NDL group 450a members comprise wireless devices 425a and 425b and NDL group 450b members comprise wireless devices 425c and 425d. Additionally, wireless devices 425g, 425h, and 425i are each members of NAN cluster 415b. As discussed herein, the NAN clusters shown in FIG. 4 comprise clusters of stations. Accordingly, reference to NAN clusters or clusters in the disclosure are intended to equate to clusters of stations. Thus, discussion of one of NAN clusters and clusters of stations is to refer to both NAN clusters and clusters of stations. These three wireless devices may communicate with each other even though they do not share wireless access points. Similarly, wireless devices 425e and 425f are each members of NAN 415c and may communicate with each other via NAN 415c even though they do not share a common wireless access point. Each NAN cluster 415a-c has its own timing so timing in one NAN cluster (e.g., NAN cluster 415a) may not be synchronous with another NAN cluster (e.g., NAN cluster 415b).

NAN clusters 415a-c represent communication networks among wireless devices 425a-j in close proximity. The NAN clusters 415a-c allow wireless devices 425a-j that may not share the same network infrastructure but that are geographically close to communicate which other in a more efficient manner than over the wireless networks 405a-c. The NAN clusters 415a-c focus on two-way communications between wireless devices, allowing wireless devices in close proximity to communicate with each other without having to go through the wireless networks 405a-c. Similarly, NAN clusters 415a-c allow their respective wireless devices that do share a wireless network 405a-c to communicate with each other without utilizing the inefficient communication path of wireless network 405a-c through the wireless access point 410a-c and instead communicate directly with each other. Additionally, NAN clusters 415a-c allow communication between their respective wireless devices that do not belong to wireless networks 405a-c, for example wireless device 425f. NAN cluster 415c may allow wireless device 425f to communicate with wireless device 425e even though wireless device 425f is not connected to any wireless network 405a-c.

In some embodiments, a wireless device currently a member of a NAN cluster may periodically scan outside its own discovery windows (DWs) to determine if there exists a neighboring NAN cluster with a better cluster grade than its current cluster or if a neighboring cluster with a better cluster grade is identified. Wireless devices may merge to a cluster with a better cluster grade if they determine the merger is beneficial. A cluster grade may be determined using various cluster metrics, including, but not limited to, cluster age (where older clusters may have better grades), cluster size (more devices may have better grades), number of available services in the cluster (more available services may mean better grades), or master preference of an anchor master device, which may be indicated in discovery and/or synchronization beacons and/or frames. In some embodiments, the cluster grade may refer to a ranking of clusters of stations, such that a high cluster grade is associated with a cluster of stations that is preferred over clusters of stations having low cluster grades.

The above listing is meant to be exemplary and not limiting. The determination of a cluster grade is exemplary in the embodiments below, and is not meant to be limiting. Determination of a “better” neighboring cluster with which to merge may involve comparison of the number of services offered, or number of devices therein, or age, among others. In some embodiments, a cluster with a better cluster grade than the current cluster may comprise a cluster that is preferred over the current cluster. For example, a cluster have an older cluster age may be preferred over a cluster having a younger cluster age. Similarly, a cluster of stations having a larger cluster size (for example, having a larger number of devices as part of the cluster) may be preferred over a cluster having a smaller cluster size. A cluster of stations having more available services may be preferred over a cluster of stations with fewer available services. Additionally, the preferred cluster of stations or better cluster grade for a cluster of stations may vary dependent upon the wireless device or groups of wireless devices (e.g., NDL group); for example, for some wireless devices, the number of services available on the cluster of stations may be more important than the age of the cluster or the number of stations in the cluster. Accordingly, the request for these wireless devices may place more importance on the number of services than the other factors. The embodiments below discussing neighboring clusters with better cluster grades is exemplary and not meant to be limiting of what is a better neighboring cluster and how a better neighboring cluster is determined.

As discussed above, each NAN cluster (e.g., NAN cluster 415a-c) has its own timing and so devices moving from one NAN cluster to another may experience timing issues as a result of merging. Additionally, an NDL group relies on synchronization from its underlying NAN cluster. Accordingly, some issues may occur when some members of a NAN cluster move to a different cluster. Embodiments described herein address some issues created with NAN cluster mergers. For example, embodiments described herein may prevent unnecessary merger of NAN clusters, may address issues related to a transition of an NDL group, may determine whether a slow or fast transition to the new NAN cluster is desirable, and/or determine how to accommodate devices that have long wake-up periods (e.g., 8 seconds).

Determination of Merger

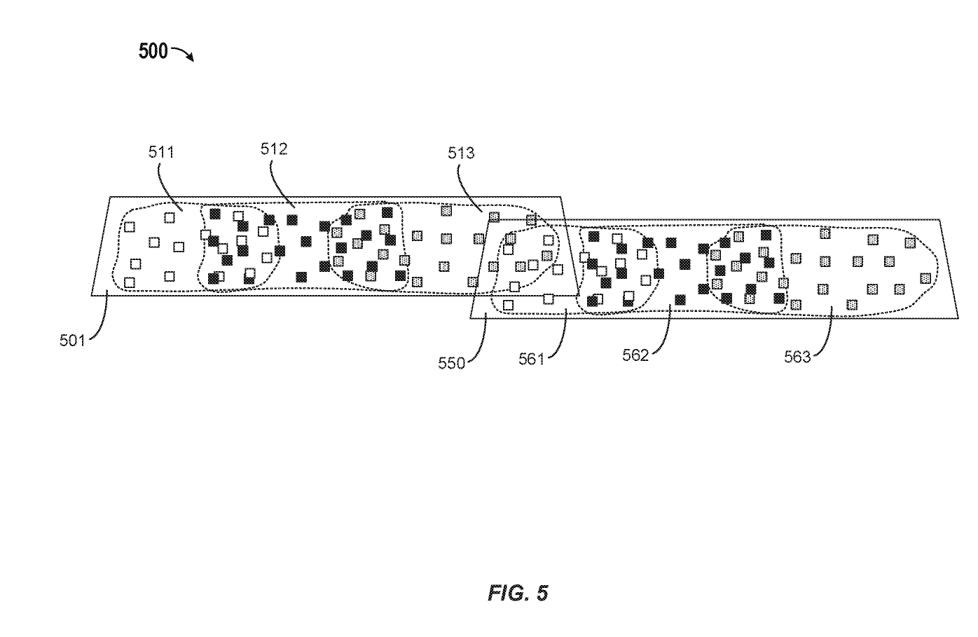

FIG. 5 shows an exemplary embodiment of a communication system 500. FIG. 5 shows two NAN clusters 501 and 550 partially overlapping. As illustrated, NAN cluster 501 comprises NDL groups 511, 512, and 513 and NAN cluster 550 comprises NDL groups 561, 562, and 563. In some embodiments, a NDL group may identify a NAN cluster with a better or higher cluster grade than its current NAN cluster and may then determine whether to move to the NAN cluster with the better cluster grade. For example, devices in NDL group 561 may come within range of NAN cluster 501 and determine that the NAN cluster 501 has a better cluster grade than its NAN cluster 550. The NDL group 561 may then determine whether to move to the NAN cluster 501 based on certain criteria.

In some embodiments, the criteria may comprise some form of hysteresis to determine whether to move to NAN cluster 501. For example, the hysteresis may require that the NAN cluster 501 having a better cluster grade stay in proximity to the NAN cluster 550 for a certain predetermined time period threshold. For example, the predetermined time period may comprise 5 seconds, 30 seconds, or several minutes. If the threshold is satisfied, then the NDL group 561 may proceed to move to the NAN cluster 501. Such a hysteresis requirement may prevent mergers to transitory NAN clusters such as a NAN cluster on board a bus or train that is quickly passing through the current NAN cluster. Such prevention of unnecessary NAN cluster mergers may reduce energy consumed and messaging overhead during such transitions and/or may increase the efficiency of the NAN cluster.

In other embodiments, the decision to move to NAN cluster 501 may be delegated to a “leader” member of the NDL group 561. In such embodiments, NDL members are each assigned “weights” to them based on certain criteria. In some aspects, the criteria may be based on which member or members are the source of data traffic or the source of an application (e.g., music or video files) in the NDL group 561. The member with the highest weight assigned to it may be designated the “leader” for the NDL group 561. Other NDL group 561 members transmit information regarding other NAN clusters (e.g., NAN cluster 501) to the leader member and the leader makes the decision on whether to move to the new NAN cluster 501 based on certain criteria. As discussed above, the criteria may comprise the cluster grade of the NAN clusters, the size of the NAN cluster, the services offered, etc. One advantage of such a “follow the leader” decision scheme is that often an NDL group has no meaning without a leader member providing the source of the traffic (e.g., music, photo, video traffic). Accordingly, it is logical for other NDL group members to follow the leader member's decision rather than waste resources making such a determination.

In some embodiments, the criteria used to determine whether to move to NAN cluster 501 may comprise an election of the NDL group 561 members. In such an election, each NDL group member sends a broadcast to indicate its preference regarding whether or not it would prefer to merge with the NAN cluster 501. As discussed above, each individual NDL member's preference may be based on certain criteria such as cluster size, services offered, timing, etc. In some aspects, the message requesting the election may occur during a discovery window of the NAN, in the paging window of the NDL group scheduling, or in a NDL time-block. As a non-limiting example, the NDL time block may have a size of 32 time units (TU) and the duration of the first paging window may be a percentage of the NDL time-block. The decision to move to NAN cluster 501 may be based on a majority of the NDL group members or based on another predetermined percentage threshold, such as 50%, 60%, 70%, 80% or the like. This type of selection criteria allows for a more democratic selection of the NAN cluster and promotes success of the transition to the new NAN cluster because the NAN cluster merger tends to be more successful when most of the NDL group participants move together.

In some embodiments, the NDL group 561 members may decide to remain in its current NAN cluster 550 as long as the NDL is “active” or has services being offered. For example, four of ten devices of the NDL group 561 may be participating in a photo session and the NDL group 561 may receive information indicating that NAN cluster 501 has a better cluster grade. These four devices may decide to stay in NAN cluster 550 until the photo session has completed before moving to NAN cluster 501 while the other six devices transition to NAN cluster 501 immediately. In some aspects, if one of the six devices that move from the NAN cluster 550 comprises the anchor master device, one of the four remaining NDL group 561 members may take on the master role for the NAN cluster 550 (e.g., anchor master device). This way the NDL remains un-interrupted and the timing of the NDL group is not lost.

Method of Transition

Once the NDL group 561 has determined to merge with the NAN cluster 501, the NDL group 561 may now determine on how best to transition its members to the new NAN cluster 501 from the NAN cluster 550. In some embodiments, the NDL group 561 members may each make an independent decision to transition to the new NAN cluster (e.g., NAN cluster 501). Each member advertises its decision to transition to the NAN cluster 501 during the NAN cluster 501 or 550 discovery window, in the paging window of the NDL group 561, or in a NDL time-block. The NDL group 561 member will then join the NAN cluster 501 but may persist on the NDL logical channel with new DW timing of the NAN cluster 501. After moving to the new cluster, the NDL group 561 member may compute the offsets of the NDL logical channel with respect to the new DW of the new NAN cluster 501.

In some embodiments, the NDL group 561 members may maintain membership across both the NAN clusters 501 and 550 to determine on how best to transition to the new NAN cluster 501. In some aspects, the NDL group 561 members wake-up during both the NAN clusters 501 and 550 DWs while maintaining the same NDL logical channel schedule. Each of the NDL group 561 members then advertise a countdown timer on the NAN cluster it plans to leave (i.e., NAN cluster 550) based on certain criteria (e.g., services, cluster size, timing, etc.). In some aspects, the NDL group 561 members advertises their countdown timer during the NAN cluster 550 discovery window or in a NDL time-block of the NDL group 561. This option allows a NDL group 561 member to make an informed decision on which NAN cluster to join by maintaining membership to both NAN clusters for a period of time so that the member can ascertain the quality of both clusters. In some embodiments, after the maintaining membership across both NAN clusters 501 and 550, the NDL group 561 may decide to stay with the NAN cluster 550 or move to the new NAN cluster 501.

In some embodiments, the NDL group 561 may only be valid for a certain amount of time to aid in the transition of the NDL group 561 to the NAN cluster 501. The validity time of the NDL group may comprise a property of the logical channel. For example, an NDL group 561 member may advertise and provide a service and as part of the attributes of the NDL group, the NDL group may expire every 5 seconds. Then the service provider member is obligated to extend the duration of the NDL group 561 for another 5 seconds before the expiration of the 5 second validity time. Therefore, validity time puts a time boundary on the life of the NDL group 561. An advantage of time boundary is that the NDL group 561 can set a clear time period (e.g., after the expiry of the validity time) for the NDL group 561 to move to the NAN cluster 501. NDL group 561 members may exchange information regarding the new NAN cluster 501 before the expiry of the group validity time to also aid in the transition to the NAN cluster 501.

Speed of Transition

Once the NDL group members determine how to transition to a new NAN cluster, the determination on how fast the transition takes place may be a property of the logical channel (e.g., NDL schedule or NDL wake-up period). For example, as described above, NDL groups may have certain defined attributes relating to latency requirements for different applications running in the NDL group. Some applications, such as video calls or voice chat, may have very low latency requirements which have short wake-up periods. This means that the NDL group wakes-up very frequently in order to send the data without loss of voice or video packets. For NDL groups with low latency requirements, the transition to the new NAN cluster (e.g., NAN cluster 501) may occur faster than NDL groups with high latency requirements (e.g., property of the logical channel). Similarly, NDL groups with high latency requirements (e.g., longer wake-up periods) may transition to the new NAN cluster slower than NDL groups with low latency requirements.

Devices with Long Wake-Up Times

In some embodiments, some NDL group 561 members may have longer NAN wake-up schedules (e.g., devices wake-up every 8 seconds to participate in NAN service discovery operation during NAN discovery window (DW)). For these devices, the NDL group 561 provides a wake-up schedule that occurs more frequently. All devices that are part of the NDL group 561 will therefore wake-up during both the NAN wake-up schedule (i.e., NAN DW) and the NDL group 561 wake-up schedule (i.e., NDL transmission schedule). For example, a NDL group 561 member may have a NAN wake-up schedule of 8 seconds, but the NDL group 561 is running a photo sharing application that has a wake-up schedule of 128 ms so that NDL group 561 members will wake-up every 128 ms to send or receive photo sharing data. Since the NDL group 561 members will wake-up every 128 ms, the NDL group 561 can inform all members about the NAN cluster 501 merge during the more frequent wake-up periods so that devices with long NAN wake-up times are informed and may participate in the merge. In some aspects, the paging window size may grow due to the increased information. However, such NAN cluster merger or transition messages may be rare and may have high access category (high priority) and/or low contention window size to limit the effect of the larger paging window.

FIG. 6A is a flowchart of a method 600 of merging neighbor aware network (NAN) clusters. The method 600 may be performed, in some aspects, by any of wireless devices 130a-1, the wireless device 202, and/or wireless devices 425a-j. In some aspects, the method 600 may be performed by any suitable device.

In block 610, a device of a NAN data link (NDL) group in a first NAN cluster identifies a neighboring NAN cluster with a better cluster grade than the first NAN cluster. In some aspects, the NAN data link (NDL) group identified in block 610 may be substantially similar to the NDL group 561 described with respect FIG. 5. In some aspects, the neighboring NAN cluster with a better cluster grade may be substantially similar to the NAN cluster 501 described with respect FIG. 5.

In block 620, the device determines whether the NDL group is still active. In block 630, the device remains in the first NAN cluster as long as the NDL group is active. In block 640 the device merges with the neighboring NAN cluster after the NDL group is no longer active.

FIG. 6B is a flowchart of a method 650 of merging neighbor aware network (NAN) clusters. The method 650 may be performed, in some aspects, by any of wireless devices 130a-1, the wireless device 202, and/or wireless devices 425a-j. In some aspects, the method 650 may be performed by any suitable device.

In block 651, a device of a NAN data link (NDL) group in a first NAN cluster identifies a neighboring NAN cluster with a better cluster grade than the first NAN cluster. In some aspects, the NAN data link (NDL) group identified in block 610 may be substantially similar to the NDL group 561 described with respect FIG. 5. In some aspects, the neighboring NAN cluster with a better cluster grade may be substantially similar to the NAN cluster 501 described with respect FIG. 5.

In block 652, the device joins the neighboring NAN cluster while remaining in the first NAN cluster. In block 653, the device determines whether to merge with the neighboring NAN cluster based on information from the neighboring NAN cluster and the first NAN cluster. In block 654, the device announces the determination of whether to merge on at least one of the first NAN cluster and the neighboring NAN cluster.

FIG. 7 is a flowchart of a method 700 of merging neighbor aware network (NAN) clusters. The method 700 may be performed, in some aspects, by any of wireless devices 130a-1, the wireless device 202, and/or wireless devices 425a-j. In some aspects, the method 700 may be performed by any suitable device.

At block 702, a device identifies a neighboring NAN cluster with a better cluster grade than the current NAN cluster of the device. At block 704, the device makes a determination of whether to merge with the neighboring NAN cluster. The device may choose one or more options to make the determination. At block 705, the device may check to see whether a hysteresis threshold has been satisfied. In some aspects, the hysteresis threshold may comprise a time period where the neighboring NAN cluster maintains a better cluster grade than the current NAN cluster. If the neighboring NAN cluster does not satisfy the hysteresis threshold, then at block 710 the device remains in the current NAN cluster and then returns to block 702 to look for a new neighboring NAN cluster. If the neighboring NAN cluster does satisfy the hysteresis threshold, then at block 709, the device makes the determination to merge into the neighboring NAN cluster.

At block 706, the device may check whether a leader device of the NDL group has decided to merge with the neighboring NAN cluster. If so, then the device will follow the leader and at block 709, the device makes the determination to merge into the neighboring NAN cluster. If the leader decides not to merge with the neighboring NAN cluster, then at block 710 the device remains in the current NAN cluster. In some embodiments, the device may comprise the leader device of the NDL group and make the determination of whether to merge based on certain criteria (e.g., cluster size, services offered, age of cluster, etc.).

At block 707, the device may check whether the members of the NDL group have decided to merge with the neighboring NAN cluster. The members may decide based on an election of the members where each of the members sends its preference to merge or not. If the majority or some other percentage of the members decide to merge, then at block 709, the device makes the determination to merge into the neighboring NAN cluster. If the members elect not to merge with the neighboring NAN cluster, then at block 710 the device remains in the current NAN cluster.

At block 708, the device may check whether the NDL group is still active and may hold off merging with the neighboring NAN cluster until the NDL group is no longer active. Once the NDL is no longer active, then at block 709, the device makes the determination to merge into the neighboring NAN cluster. If the NDL group remains active, then at block 710 the device remains in the current NAN cluster. The NDL group may remain active as long as it continues to provide a service or use an application.

If the device has determined to merge into the neighboring NAN cluster at block 709, then the device may make a determination of how to transition or effectuate the merger. At block 711, each member of the NDL group may make an independent decision on when, and/or if, to transition to the neighboring NAN cluster. Each device may advertise its decision in the NAN DW and/or in the NDL group PW. Once the device joins the neighboring NAN cluster, it may persist on the same NDL logical channel with the new DW timing of the neighboring NAN cluster. The new DW timing may be based on an offset of the previous NAN cluster DW timing.

At block 712, the device may maintain membership across both NAN clusters for a period of time. During this time, the device wakes-up according to both DW of the NAN clusters while maintaining the same NDL logical channel. By maintaining membership across both NAN clusters the device may be able to receive more information about both NAN clusters and make a determination on which cluster is best suited for the device. Once the device makes its determination, the device may advertise a countdown timer on the NAN cluster it has decided to leave based on certain criteria or based on the information received from both. At the end of the countdown timer, the device may leave one NAN cluster and remain on the other.

At block 713, the device may transition to the neighboring NAN cluster based on an NDL validity time. In some aspects, the NDL group may only be valid for a certain amount of time. That time may be extended by one or more of the members of the NDL group. The device may decide not to move to the neighboring NAN cluster until after the NDL validity time has expired.

After the device has determined how to transition to the neighboring NAN cluster, at block 714, the device may transition fast or slow depending on a property of the logical channel. For example, if the property of the logical channel is the NDL group timing schedule and the NDL group timing schedule has low latency requirements or a short wake-up period (e.g., 20 ms), then the transition may occur quickly. However, if the NDL group timing schedule has a high latency or longer wake-up period (e.g., 128 ms), then the transition may occur more slowly than the NDL group with a wake-up period of 20 ms. At block 715, the merger to the neighboring NAN cluster is complete and the method ends.

Those of skill would further appreciate that the various illustrative logical blocks, configurations, modules, circuits, and algorithm steps described in connection with the embodiments disclosed herein may be implemented as electronic hardware, computer software, or combinations of both. Various illustrative components, blocks, configurations, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The steps of a method or algorithm described in connection with the embodiments disclosed herein may be embodied directly in hardware, in a software module executed by a processor, or in a combination of the two. A software module may reside in random access memory (RAM), flash memory, read-only memory (ROM), programmable read-only memory (PROM), erasable programmable read-only memory (EPROM), electrically erasable programmable read-only memory (EEPROM), registers, hard disk, a removable disk, a compact disc read-only memory (CD-ROM), or any other form of storage medium known in the art. An exemplary non-transitory (e.g., tangible) storage medium is coupled to the processor such that the processor can read information from, and write information to, the storage medium. In the alternative, the storage medium may be integral to the processor. The processor and the storage medium may reside in an application-specific integrated circuit (ASIC). The ASIC may reside in a computing device or a user terminal. In the alternative, the processor and the storage medium may reside as discrete components in a computing device or user terminal.

The previous description of the disclosed embodiments is provided to enable a person skilled in the art to make or use the disclosed embodiments. Various modifications to these embodiments will be readily apparent to those skilled in the art, and the principles defined herein may be applied to other embodiments without departing from the scope of the disclosure. Thus, the present disclosure is not intended to be limited to the embodiments shown herein but is to be accorded the widest scope possible consistent with the principles and novel features as defined by the following claims.

What is claimed is:

1. A method for managing wireless communication, comprising:
identifying, at a device of a first wireless network cluster, a neighboring wireless network cluster;
determining whether to merge with the neighboring wireless network cluster based on a cluster grade of first wireless network cluster and a cluster grade of the neighboring wireless network cluster; and
announcing a decision to merge the device with the neighboring wireless network cluster.

2. The method of claim 1, wherein the determining whether to merge with the neighboring wireless network cluster is based on a determination made by a designated leader device of the first wireless network cluster.

3. The method of claim 2, wherein the designated leader device is selected based on one or more of a weight assigned to each participating device in the first wireless network cluster, and wherein the weight of each participating device is based at least in part on whether the participating device is a source of a service.

4. The method of claim 1, wherein the determining whether to merge with the neighboring wireless network cluster is based on an election result of votes from a plurality of devices in a group supported by the first wireless network cluster.

5. The method of claim 2, wherein the determination made by the designated leader device is based on one or more of a proximity to the neighboring wireless network cluster, a number and a type of services offered in the neighboring wireless network cluster, and a number of devices present in the neighboring wireless network cluster.

6. The method of claim 1, wherein the determining whether to merge with the neighboring wireless network cluster is based on one or more of a satisfaction of a predetermined hysteresis criterion associated with an availability of the neighboring wireless network cluster, a timing schedule of the neighboring wireless network cluster, and a determination of whether a service or application used by the device is being provided to a group supported by the first wireless network cluster.

7. The method in claim 6, wherein the hysteresis criterion comprises an amount of time passed since the neighboring wireless network cluster was detected.

8. The method of claim 2, wherein the determination made by the designated leader device occurs when the cluster grade of the neighboring wireless network cluster is higher than the cluster grade of first wireless network cluster.

9. The method of claim 2, further comprising obtaining the determination of the designated leader device.

10. A wireless communication device in a group supported by a first wireless network cluster, comprising:
a processor configured to:
identify a neighboring wireless network cluster;
determine whether to merge with the neighboring wireless network cluster based on a cluster grade of first wireless network cluster and a cluster grade of the neighboring wireless network cluster; and
announce a decision to merge the wireless communication device with the neighboring wireless network cluster.

11. The wireless communication device of claim 10, wherein the processor is further configured to determine whether to merge with the neighboring wireless network cluster based on a determination made by a designated leader device of the first wireless network cluster.

12. The wireless communication device of claim 11, wherein the designated leader device is selected based on one or more of a weight assigned to each participating device in the first wireless network cluster, and wherein the weight of each participating device is based at least in part on whether the participating device is a source of a service.

13. The wireless communication device of claim 10, wherein the processor is further configured to determine whether to merge with the neighboring wireless network cluster based on an election result of votes from a plurality of devices in a group supported by the first wireless network cluster.

14. The wireless communication device of claim 11, wherein the determination made by the designated leader device is based on one or more of a proximity to the neighboring wireless network cluster, a number and a type of services offered in the neighboring wireless network cluster, and a number of devices present in the neighboring wireless network cluster.

15. The wireless communication device of claim 10, the processor is further configured to determine whether to merge with the neighboring wireless network cluster based on one or more of a satisfaction of a predetermined hysteresis criterion associated with an availability of the neighboring wireless network cluster, a timing schedule of the neighboring wireless network cluster, and a determination of whether a service or application used by the wireless communication device is being provided to a group supported by the first wireless network cluster.

16. The wireless communication device of claim 15, wherein the hysteresis criterion comprises an amount of time passed since the neighboring wireless network cluster was detected.

17. The wireless communication device of claim 11, wherein the determination made by the designated leader device occurs when the cluster grade of the neighboring wireless network cluster is higher than the cluster grade of first wireless network cluster.

18. The wireless communication device of claim 11, further comprising a transmitter configured to transmit the determination made by the designated leader device.

19. The wireless communication device of claim 11, further comprising a receiver configured to receive the determination made by the designated leader device.

20. A wireless communication device in a group supported by a first wireless network cluster, comprising:
means for identifying a neighboring wireless network cluster;
means for determining whether to merge with the neighboring wireless network cluster based on a cluster grade of first wireless network cluster and a cluster grade of the neighboring wireless network cluster; and
means for announcing a decision to merge the wireless communication device with the neighboring wireless network cluster.

21. The wireless communication device of claim 20, wherein the means for determining whether to merge with the neighboring wireless network cluster comprises means for determining whether to merge with the neighboring wireless network cluster based on a determination made by a designated leader device of the first wireless network cluster.

22. The wireless communication device of claim 21, wherein the designated leader device is selected based on one or more of a weight assigned to each participating device in the first wireless network cluster, and wherein the weight of each participating device is based at least in part on whether the participating device is a source of a service.

23. The wireless communication device of claim 21, further comprising means for receiving the determination made by the designated leader device.

24. The wireless communication device of claim 20, wherein the means for determining whether to merge with the neighboring wireless network cluster comprises means for determining whether to merge with the neighboring wireless network cluster based on one or more of a proximity to the neighboring wireless network cluster, a number and a type of services offered in the neighboring wireless network cluster, a number of devices present in the neighboring wireless network cluster, a satisfaction of a predetermined hysteresis criterion associated with an availability of the neighboring wireless network cluster, a timing schedule of the neighboring wireless network cluster, and a determination of whether a service or application used by the wireless communication device is being provided to a group supported by the first wireless network cluster.

25. The wireless communication device of claim 24, wherein the hysteresis criterion comprises an amount of time passed since the neighboring wireless network cluster was detected.

26. A non-transitory computer readable storage medium comprising instructions that when executed cause a processor to perform a method for merging neighbor aware network (NAN) clusters, comprising:
identifying, at a device of a first wireless network cluster, a neighboring wireless network cluster;
determining whether to merge with the neighboring wireless network cluster based on a cluster grade of first wireless network cluster and a cluster grade of the neighboring wireless network cluster; and
announcing a decision to merge the device with the neighboring wireless network cluster.

27. The medium of claim 26, wherein the determining whether to merge with the neighboring wireless network cluster is based on a determination made by a designated leader device of the first wireless network cluster.

28. The medium of claim 27, wherein the designated leader device is selected based on one or more of a weight assigned to each participating device in the first wireless network cluster, and wherein the weight of each participating device is based at least in part on whether the participating device is a source of a service.

29. The medium of claim 26, wherein the determining whether to merge with the neighboring wireless network cluster is based on an election result of votes from a plurality of devices in a group supported by the first wireless network cluster.

30. The medium of claim 26, wherein the determining whether to merge with the neighboring wireless network cluster is based on one or more of a proximity to the neighboring wireless network cluster, a number and a type of services offered in the neighboring wireless network cluster, a number of devices present in the neighboring wireless network cluster, a satisfaction of a predetermined hysteresis criterion associated with an availability of the neighboring wireless network cluster, a timing schedule of the neighboring wireless network cluster, and a determination of whether a service or application used by the device is being provided to a group supported by the first wireless network cluster.
